(19) United States
(12) Patent Application Publication
(10) Pub. No.: US 2007/0281616 A1
(43) Pub. Date: Dec. 6, 2007

(54) Communications integration apparatus to integrate different network structures

(76) Inventor: Chih-Yu Chen, Sindian City (TW)

Correspondence Address: HERSHKOVITZ & ASSOCIATES, 2845 DUKE STREET, ALEXANDRIA, VA, 22314, US

(21) Appl. No.: 11/447,274

(22) Filed: Jun. 6, 2006

(51) Int. Cl. H04B 7/00

(52) U.S. Cl. 455/41.2

(57) ABSTRACT

A communication integration apparatus has a portable integration device, a personal computer, a Public Switched Telephone Network (PSTN) adapter and a cellular phone. The portable integration device provides capabilities including inputting messages, displaying messages, communicating like a phone and delivering and receiving data and commands in bluetooth protocols. The personal computer has Internet phone software, instant message software, an interface module and a first bluetooth connector. The interface module captures data from Internet phone software and instant message software. The first bluetooth connector connects interface module in the personal computer to the portable integration device. The PSTN adapter transforms PSTN signals to and from digital data and has a second bluetooth connector that connects the PSTN adapter to the portable integration device. The cellular phone has a bluetooth communication capability to connect to the portable integration device.

### BACKGROUND OF THE INVENTION

1. Field of the Invention

The present invention relates to a communications integration apparatus, and more particularly to a communications integration apparatus to integrate different communication network structures.

2. Description of Related Art

Clients in a communication network, such as Cellular Phone Network, Public Switched Telephone Network (PSTN), Internet Phone Network, Instant Message Network or the like, connect to each other through exclusive network structures and service providers. Users have to use specific compatible devices to connect to a specific network structure of each communication network to use the services.

To integrate communications among different communication networks, some services providers use gateways to interconnect network structures of communication networks. For example, cellular phones can answer or place PSTN phone calls through gateways provided by the service provider.

However, gateways for integrating communications among different communication networks are quite expensive. For this reason, most service providers are not interested in spending the money necessary to install gateways.

To overcome the shortcomings, the present invention provides a communications integration apparatus to integrate different network structures to mitigate or obviate the aforementioned problems.

### SUMMARY OF THE INVENTION

The main objective of the invention is to provide a communications integration apparatus to integrate different communication network structures.

To achieve the objective, a communications integration apparatus in accordance with the present invention comprises a portable integration device, a personal computer, a Public Switched Telephone Network (PSTN) adapter and a cellular phone. The portable integration device is the primary component of the communications integration apparatus and performs a wide range of functions including inputting messages, displaying messages, communicating like a phone and delivering/receiving data and commands in bluetooth protocols. The personal computer has Internet phone software, instant message software, an interface module and a first bluetooth connector. The interface module captures data from Internet phone software and instant message software. The first bluetooth connector connects interface module in the personal computer to the portable integration device. The PSTN adapter transforms PSTN signals to and from digital data and has a second bluetooth connector. The second bluetooth of the PSTN adapter connects the PSTN adapter to the portable integration device. The cellular phone has a bluetooth communication capability to connect to the portable integration device.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a communications integration apparatus in accordance with the present invention; and

FIG. 2 is a functional block diagram of a portable integration device in the communications integration apparatus in FIG. 1.

### DETAILED DESCRIPTION OF PREFERRED EMBODIMENT

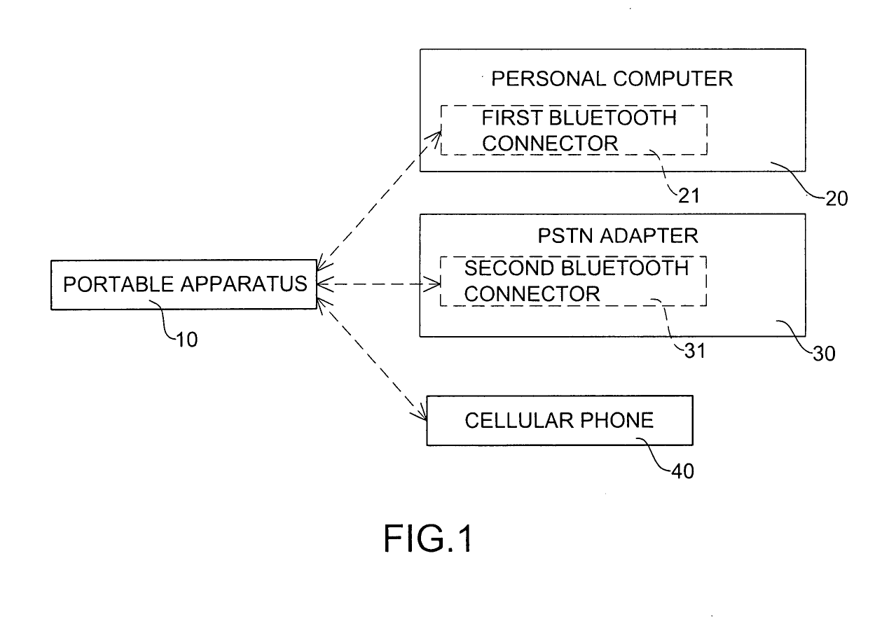

With reference to FIG. 1, a communications integration apparatus in accordance with the present invention to integrate communications among different communication networks such as cellular phones, Public Switched Telephone Network (PSTN) phones, Internet phones and instant messaging comprises a portable integration device (10), a personal computer (20), a PSTN adapter (30) and a cellular phone (40).

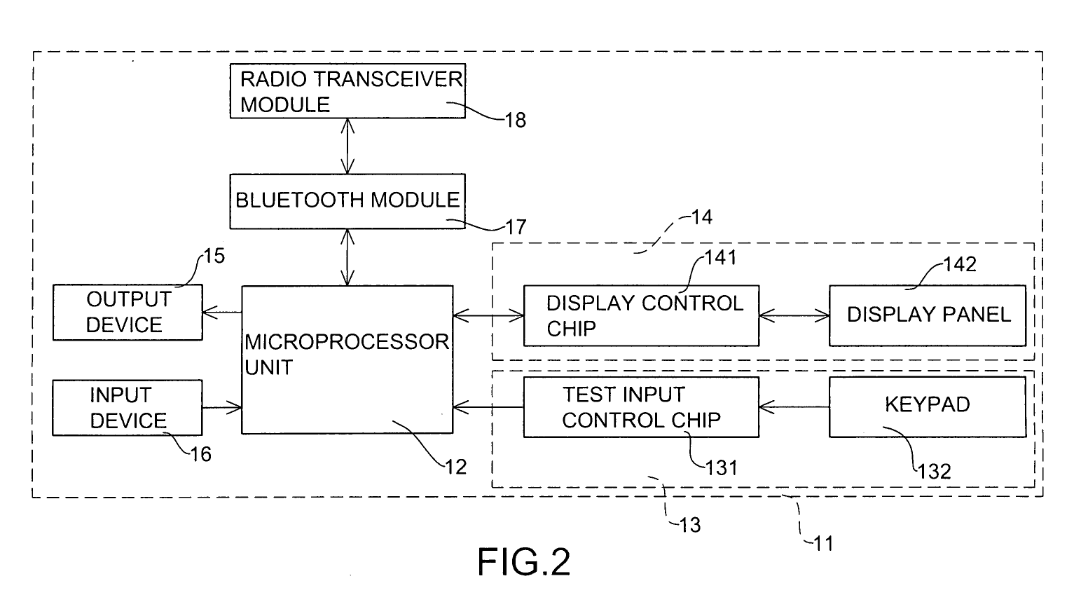

With further reference to FIG. 2, the portable integration device (10) performs a wide range of functions including inputting messages, displaying messages, communicating like a phone and delivering/receiving data and commands in bluetooth protocols and comprises a casing (11), a microprocessor unit (12), a text input module (13), a display module (14), an output device (15), an input device (16), a bluetooth module (17) and a radio transceiver module (18).

The microprocessor unit (12) is mounted in the casing (11), processes and stores data and sends out commands.

The text input module (13) is connected to the microprocessor unit (12) and comprises a text input control chip (131) and a keypad (132). The text input control chip (131) is mounted in the casing (11). The keypad (132) may be an alphanumeric keypad, is mounted in and exposed through the casing (11) and is connected to the microprocessor unit (12) through the text input control chip (131) to input words, numbers and strings of text.

The display module (14) is connected to the microprocessor unit (12), displays messages and system status and comprises a display control chip (141) and a display panel (142). The display control chip (41) is mounted in the casing (11). The display panel (142) may be a liquid crystal display (LCD) panel, is mounted in and exposed through the casing (11) and is connected to the microprocessor unit (12) through the display control chip (141).

The output device (15) can be a speaker, is mounted in the casing (11) and is connected to the microprocessor unit (12).

The input device (16) can be a microphone, is mounted in the casing (11) and is connected to the microprocessor unit (12).

The bluetooth module (17) is mounted in the casing (11) and is connected to the microprocessor unit (12) to transform bluetooth protocol signals to data and commands that is used by the microprocessor unit (12) and to transform data and commands from the microprocessor unit (12) to bluetooth protocol signals. The blue protocols may be Handset Profile protocol, Handsfree Profile protocol, Serial Port Profile protocol, Cordless Telephone Profile protocol or the like.

The radio transceiver module (18) is connected to the bluetooth module (17) to send and receive radio signals in bluetooth protocols.

The personal computer (20) may be a desktop or a notebook computer, has Internet phone software, instant message software, an interface module and a first bluetooth connector (21). The interface module may be implemented in hardware or software and is compatible with and captures data from Internet phone software and instant message software, such as MSN, Skype or the like. The first bluetooth connector (21) connects the interface module in the personal computer (20) to the portable integration device (10) and delivers and receives data and commands to and from the portable integration device (10) in bluetooth protocols.

The PSTN adapter (30) transforms PSTN signals to and from digital data and has a second bluetooth connector (31). The second bluetooth connector (31) connects the PSTN adapter (30) to the portable communication device (10) and delivers and receives data and commands to and from the portable integration device (10) in bluetooth protocols, such as Cordless Telephone Profile protocol.

The cellular phone (40) has a bluetooth communication capability to connect the cellular phone (40) to the portable integration device (10), delivers and receives data and commands to and from the portable integration device (10) in bluetooth protocols, such as Handset Profile protocol and Handfree Profile protocol.

With such a communication integration apparatus, the portable integration device (10) can simultaneously deliver and receive data and commands to and from the personal computer (20), the PSTN adapter (30) and the cellular phone (40). Therefore, central gateways are no longer required to integrate communications among different communication networks such as Cellular Phone Network, PSTN, Internet Phone Network and Instant Message Network. The communication integration apparatus provides a cheaper and easier solution than conventional means to integrate communications among different communication networks.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A communications integration apparatus to integrate communications among different communication networks comprising
a portable integration device performing functions including inputting messages, displaying messages, communicating like a phone, delivering and receiving data and commands in bluetooth protocols;
a personal computer having
Internet phone software;
instant message software;
an interface module being compatible with Internet phone software and instant message software and capturing data from Internet phone software and instant message software; and
a first bluetooth connector connecting the interface module in the personal computer to the portable integration device and delivering and receiving data and commands to and from the portable integration device in bluetooth protocols;
a PSTN adapter transforming PSTN signals to and from digital data and having a second bluetooth connector connecting the PSTN adapter to the portable integration device and delivering and receiving data and commands to and from the portable integration device in bluetooth protocols; and
a cellular phone having a bluetooth communication capability to connect the cellular phone to the portable apparatus and delivering and receiving data and commands to and from the portable integration device in bluetooth protocols;
whereby the portable integration device directly connects to the personal computer, the PSTN phone and the cellular phone to communicate with Internet Phone Network, Instant Message Network, PSTN and Cellular Phone Network.

2. The communications integration apparatus as claimed in claim 1, wherein the portable integration device comprises
a casing;
a microprocessor unit being mounted in the casing, processing and storing data and sending out commands;
a text input module being connected to the microprocessor unit and comprising
a text input control chip being mounted in the casing; and
a keypad being mounted in and exposed through the casing and being connected to the microprocessor unit through the text input control chip;
a display module being connected to the microprocessor unit, displays messages and system status and comprises
a display control chip being mounted in the casing; and
a display panel being mounted in and exposed through the casing and being connected to the microprocessor unit through the display control chip;
an output device being mounted in the casing and being connected to the microprocessor unit;
an input device being mounted in the casing and being connected to the microprocessor unit;
a bluetooth module being mounted in the casing and being connected to the microprocessor unit to transform bluetooth protocol signals to data and commands that is used by the microprocessor unit and to transform data and commands from the microprocessor unit to bluetooth protocol signals; and
a radio transceiver module being connected to the bluetooth module to send and receive radio signals in bluetooth protocols

3. The communications integration apparatus as claimed in claim 2, wherein the keypad of the text input module is an alphanumeric keypad.

4. The communication integration apparatus as claimed in claim 2, wherein the display panel is a liquid crystal display (LCD) panel.

5. The communication integration apparatus as claimed in claim 2, wherein the output device is a speaker.

6. The communication integration apparatus as claimed in claim 2, wherein the input device is a microphone.

7. The communication integration apparatus as claimed in claim 1, wherein the personal computer is a desktop computer.

8. The communication integration apparatus as claimed in claim 1, wherein the personal computer is a notebook computer.

9. The communication integration apparatus as claimed in claim 1, wherein the blue protocols are selected from a group consisting of Handset Profile protocol, Handsfree Profile protocol, Serial Port Profile protocol and Cordless Telephone Profile protocol.

10. The communication integration apparatus as claimed in claim 1, wherein the interface module is implemented in hardware.

11. The communication integration apparatus as claimed in claim 1, wherein the interface module is implemented in software.
